(19) United States
(12) Patent Application Publication
(10) Pub. No.: US 2025/0263230 A1
(43) Pub. Date: Aug. 21, 2025

(54) METHOD FOR CONTROLLING PLATE WAREHOUSING AND PLATE STORAGE SYSTEM USING THEREOF

(71) Applicant: VEEGOO TECHNOLOGY CO., LTD., Foshan (CN)

(72) Inventors: Daliao CHEN, Foshan (CN); Jianping QIU, Foshan (CN); Jianqiang ZOU, Foshan (CN)

(21) Appl. No.: 19/060,871

(22) Filed: Feb. 24, 2025

Related U.S. Application Data
(63) Continuation of application No. PCT/CN2025/078076, filed on Feb. 19, 2025.

(30) Foreign Application Priority Data
Jan. 25, 2025 (CN) 202510120247.5

(51) Int. Cl. B65G 1/04; B65G 1/137; B65G 1/14; B66F 9/06

(52) U.S. Cl. CPC B65G 1/0407; B65G 1/14; B66F 9/063; B65G 1/1371; B65G 2201/022; B65G 2201/0223

(57) ABSTRACT

A method for controlling plate warehousing is perform as follows. A warehousing information of a to-be-warehoused plate is obtained. A vertical rack among vertical racks is determined as a warehousing rack for storing the to-be-warehoused plate based on the warehousing information. The plate moving device adjusts the to-be-warehoused plate to a first posture and the to-be-warehoused plate in the first posture is moved closer to the warehousing rack. The plate moving device adjusts the to-be-warehoused plate to a second posture and moving the to-be-warehoused plate above the warehousing rack. The plate moving device adjust the to-be-warehoused plate to a third posture and placing the to-be-warehoused plate onto a storage surface of the warehousing rack. In the first posture, a surface of the to-be-warehoused plate is parallel to the moving direction of the plate moving device. In the second posture, the to-be-warehoused plate is horizontally provided.

### CROSS-REFERENCE TO RELATED APPLICATIONS

This application is a continuation of International Patent Application No. PCT/CN2025/078076, filed on Feb. 19, 2025, which claims the benefit of priority from Chinese Patent Application No. 202510120247.5 filed on Jan. 25, 2025. The content of the aforementioned application, including any intervening amendments made thereto, is incorporated herein by reference in its entirety.

### TECHNICAL FIELD

This application relates to plate storage, and more particularly to a method for controlling plate warehousing and plate storage system using thereof.

### BACKGROUND

After the artificial stone slabs are produced, they need to be stored in the warehouse. To facilitate subsequent deep processing of the artificial stone slabs, information such as the pattern, size, and weight of the artificial stone slabs must be registered and sorted during the warehouse entry. This allows for quick selection of the artificial stone slabs with the corresponding size during out-of-storage processing. However, due to the wide variety of specifications, models, processing techniques, and types of the artificial stone slabs, and the limited storage space in the warehouse, it is not feasible to lay the artificial stone slabs flat on the ground. Instead, the vertical storage space of the warehouse is utilized, and the artificial stone slabs are stored upright using mobile shelves.

In the sorting process of the artificial stone slabs, due to the large size and heavy weight of the artificial stone slabs, gantry-type sorting equipment is commonly used to classify the artificial stone slabs. However, the traditional gantry-type sorting equipment requires a gantry frame that spans the entire storage area, occupying a large space and limiting its application in places with limited space, reducing its versatility. Additionally, many factories have height limitations, which greatly restrict the flexibility of the gantry-type sorting equipment.

Furthermore, to facilitate the artificial stone slabs' entry into the warehouse, it is generally required to keep the posture of the artificial stone slabs during movement consistent with the posture during storage in the mobile shelves, i.e., ensuring that the artificial stone slabs maintain their orientation unchanged during the movement into the warehouse. For example, the European patent (EP3275810A1) and the Italian patent (IT201900016463A1) both describe such approaches. However, maintaining a fixed posture of the slabs requires reserved space for their movement, significantly reducing the percentage of usable storage space in the warehouse and hindering the improvement of storage space efficiency. Moreover, during the movement of the slabs into the warehouse, there is a high likelihood that the surface of the slab will be perpendicular to the direction of movement, which can cause significant shaking during transport. To stabilize the movement, the speed of the slabs must be reduced, leading to a decrease in the efficiency of warehouse entry.

### SUMMARY

The purpose of the present disclosure is to propose a method for controlling plating warehousing, by optimizing the movement posture of the plate, can effectively reduce the space required for movement and increase the movement speed, thereby improving the efficiency of plate storage.

Another purpose of the present disclosure is to propose plate storage system using the method for controlling plating warehousing, which can effectively reduce the footprint of the storage system, enhance the utilization of storage space, and overcome the shortcomings of the prior art.

This application provides a method for controlling plate warehousing, the method being applied to a plate storage system, the plate storage system comprising a plurality of vertical racks and a plate moving device, the plurality of vertical racks being provided side by side at intervals along a moving direction of the plate moving device, the moving direction of the plate moving device intersecting with a plane on which a storage surface of the plurality of vertical racks is provided; and
the method comprising:
(A) obtaining a warehousing information of a to-be-warehoused plate; and determining a vertical rack among the plurality of vertical racks as a warehousing rack for storing the to-be-warehoused plate based on the warehousing information;
(B) adjusting, by the plate moving device, the to-be-warehoused plate to a first posture and moving the to-be-warehoused plate in the first posture closer to the warehousing rack;
(C) adjusting, by the plate moving device, the to-be-warehoused plate to a second posture and moving the to-be-warehoused plate above the warehousing rack; and
(D) adjusting, by the plate moving device, the to-be-warehoused plate to a third posture and placing the to-be-warehoused plate onto a storage surface of the warehousing rack;
wherein when the to-be-warehoused plate is in the first posture, a surface of the to-be-warehoused plate is parallel to the moving direction of the plate moving device;
when the to-be-warehoused plate is in the second posture, the to-be-warehoused plate is horizontally provided; and
when the to-be-warehoused plate is in the third posture, the surface of the to-be-warehoused plate is parallel to the storage surface of the warehousing rack.

In an embodiment, when the to-be-warehoused plate is in the first posture, a width of the to-be-warehoused plate in a vertical projection direction is less than or equal to a width of the plate moving device.

In an embodiment, when the to-be-warehoused plate is in the first posture, the to-be-warehoused plate is vertically provided.

In an embodiment, when the to-be-warehoused plate is in the second posture, an extending direction of a bottom edge of the to-be-warehoused plate is parallel to an extending direction of the storage surface of the plurality of vertical racks in a vertical projection direction.

In an embodiment, the plurality of vertical racks are moved relative to the plate moving device; a moving direction of the plurality of vertical racks is parallel to the moving direction of the plate moving device;
between step (A) and step (B), or between step (B) and step (C) or between step (C) and step (D), the method further comprises:
(E) adjusting a distance between the warehousing rack and a vertical rack adjacent to the storage surface of the warehousing rack to a warehousing distance.

In an embodiment, step (D) comprises:
calculating a first warehousing path based on a posture information of the to-be-warehoused plate in the second posture, a posture information of the to-be-warehoused plate in the third posture, the warehousing information of the to-be-warehoused plate, the warehousing distance and a positional information of the to-be-warehoused plate in the second posture respect to the warehousing rack; and
adjusting, by the plate moving device, the to-be-warehoused plate to the third posture according to the first warehousing path and to place the to-be-warehoused plate onto the storage surface of the warehousing rack.

In an embodiment, step (C) comprises:
calculating a second warehousing path based on a posture information of the to-be-warehoused plate in the first posture, a posture information of the to-be-warehoused plate in the second posture, the warehousing information of the to-be-warehoused plate, a width of the plate moving device and an allowable height above the warehousing rack; and
adjusting, by the plate moving device, the to-be-warehoused plate to the second posture according to the second warehousing path and to move the to-be-warehoused plate to be above the warehousing rack.

In an embodiment, step (A) comprises:
obtaining the warehousing information of the to-be-warehoused plate; and
designating, the vertical rack whose storage information matches the warehousing information as the warehousing rack for storing the to-be-warehoused plate, based on the warehousing information and a storage information of the plurality of vertical racks.

A plate storage system for executing the above method is provided, comprising:
the plurality of vertical racks;
the plate moving device; and
a control module;
wherein the plurality of vertical racks and the plate moving device are in communication with the control module;
the plate moving device comprises a mounting base, a column, a cantilever and a material picking component; the material picking component is configured to hold the to-be-warehoused plate;
the column is provided at a top of the mounting base, and the column is configured to rotate along an axis of the column relative to the mounting base;
the cantilever is configured to extend horizontally from the column and is provided on a side of the column; and the cantilever is configured to move vertically relative to the column and rotate along an axis of the cantilever relative to the column; and
the material picking component is provided at the cantilever; the material picking component is configured to move horizontally relative to the cantilever; the material picking component is configured to rotate along an axis of the material picking component relative to the cantilever; and a rotational axis of the material picking component is perpendicular to an extending direction of the cantilever.

In an embodiment, the plate storage system further comprises:
a support component;
wherein the support component is provided at a top of the mounting base and is configured to support the material picking component.

The technical solution provided by the present disclosure has the following beneficial effects.

The mounting base of the sorting equipment is replaced from the traditional gantry type to a column type, which can greatly reduce the footprint of the sorting equipment. This allows the plate moving device to be applied in more scenarios, especially in factories with limited space and/or height restrictions.

The solution uses the plate moving device to sequentially change the posture of the to-be-warehoused plate from the first posture, second posture, and third posture during the movement into the warehouse. This can effectively reduce the space required for movement and improve the speed of movement, thereby enhancing the efficiency of plate warehousing.

The structure of the plate moving device is also optimized, allowing the material picking component to have relative displacement in five different directions with respect to the mounting base. This increases the freedom of the material picking component, making it better able to accommodate the transition of the to-be-warehoused plates in different postures.

### BRIEF DESCRIPTION OF THE DRAWINGS

FIG. 1 is a structural diagram of the plate storage system according to an embodiment of the present disclosure;

FIG. 2 is a structural diagram of the to-be-warehoused plate in the first posture according to an embodiment of the present disclosure;

FIG. 3 is a structural diagram of the to-be-warehoused plate in the second posture according to an embodiment of the present disclosure;

FIG. 4 is a structural diagram of the to-be-warehoused plate in the third posture according to an embodiment of the present disclosure;

FIG. 5 is a structural diagram of the plate moving device according to an embodiment of the present disclosure;

In the figures, 100—vertical rack, 200—plate moving device, 300—to-be-warehoused plate; 1—mounting base, 2—column, 3—cantilever, 4—material picking component, 8—support component, 81—fixed seat, 82—support frame, and 83—support driver.

### DETAILED DESCRIPTION OF EMBODIMENTS

The technical solution of the present disclosure is further illustrated below through specific embodiments.

A method for controlling plate warehousing is provided, the method is applied to a plate storage system, the plate storage system includes a plurality of vertical racks and a plate moving device, the plurality of vertical racks are provided side by side at intervals along a moving direction of the plate moving device, and the moving direction of the plate moving device intersects with a plane on which a storage surface of the plurality of vertical racks is provided.

The method includes the following steps.
(A) A warehousing information of a to-be-warehoused plate is obtained; and a vertical rack among the plurality of vertical racks are determined as a warehousing rack for storing the to-be-warehoused plate based on the warehousing information.
(B) The plate moving device adjusts the to-be-warehoused plate to a first posture and moving the to-be-warehoused plate in the first posture closer to the warehousing rack.
(C) The plate moving device adjusts the to-be-warehoused plate to a second posture and moving the to-be-warehoused plate above the warehousing rack.
(D) The plate moving device adjusts the to-be-warehoused plate to a third posture and placing the to-be-warehoused plate onto a storage surface of the warehousing rack.

When the to-be-warehoused plate is in the first posture, a surface of the to-be-warehoused plate is parallel to the moving direction of the plate moving device.

When the to-be-warehoused plate is in the second posture, the to-be-warehoused plate is horizontally provided.

When the to-be-warehoused plate is in the third posture, the surface of the to-be-warehoused plate is parallel to the storage surface of the warehousing rack.

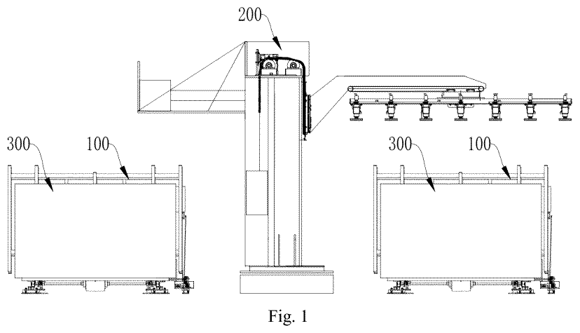

To overcome the technical drawbacks of traditional gantry-style sorting equipment, which occupies a large area and has poor versatility and flexibility, the present technical solution proposes replacing the traditional gantry-style sorting equipment with a plate moving device 200 in the plate storage system, as shown in FIG. 1. Specifically, the mounting base of the sorting equipment is replaced from the traditional gantry style to a column style, which significantly reduces the footprint of the sorting equipment. This allows the plate moving device to be applied in more scenarios, especially in factories with limited space and/or height restrictions. It should be noted that, in the plate storage system of this solution, the direction of movement of the plate moving device 200 intersects with the plane in which the storage surface of the vertical rack 100 lies, meaning that in the vertical projection direction (i.e., from a top-down visual perspective), there is an angle between the movement direction of the plate moving device 200 and the extension direction of the storage surface of the vertical rack 100.

Further, based on the use of the plate moving device 200, this technical solution proposes a method for controlling plate warehousing, which uses the plate moving device 200 to sequentially change the posture of the to-be-warehoused plate 300 from the first posture, second posture, and third posture during the movement into the warehouse. This effectively reduces the required space for movement and increases the speed of movement, thus improving the efficiency of plate warehousing.

Specifically, the method for controlling plate warehousing of this solution requires obtaining the warehousing information of the to-be-warehoused plate 300, including but not limited to the pattern, size, weight, and type of the to-be-warehoused plate 300. Then, based on the warehousing information, the vertical rack 100 used to warehouse the to-be-warehoused plate 300 is designated as the warehousing rack. It should be noted that the determination of the warehousing rack can be pre-set with the storage information of each vertical rack 100 and determined by whether the storage information matches the warehousing information. It can also be manually specified through human-machine interaction, and this is not limited here. Additionally, the warehousing information can be obtained using existing scanners or a recognition system consisting of a camera and a weighing device.

In one embodiment, the warehousing information is obtained by scanning with a scanner. Specifically, the scanner is fixed above the plate conveyor mechanism (such as a conveyor belt) to scan the plate transported by the conveyor mechanism and feedback the scanned warehousing information to the control module. In other embodiments, the scanner can also be mobile.

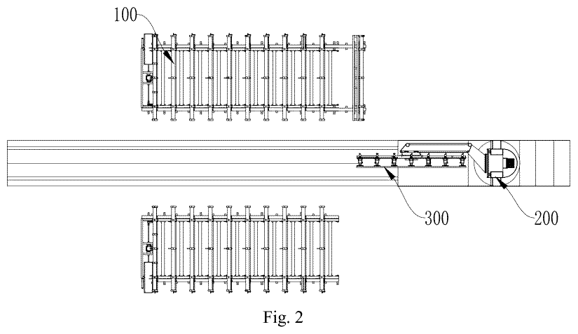

After determining the warehousing rack, the first transfer of the to-be-warehoused plate 300 is performed, which means adjusting the to-be-warehoused plate 300 to the first posture and moving it to one side of the warehousing rack. In this solution, the first posture refers to when the to-be-warehoused plate 300's surface is parallel to the movement direction of the plate moving device 200, as shown in FIG. 2. This posture can greatly reduce the resistance of the to-be-warehoused plate 300 during movement. On one hand, it prevents significant shaking of the to-be-warehoused plate 300 during movement, and on the other hand, it effectively increases the speed of plate movement, thus improving warehousing efficiency.

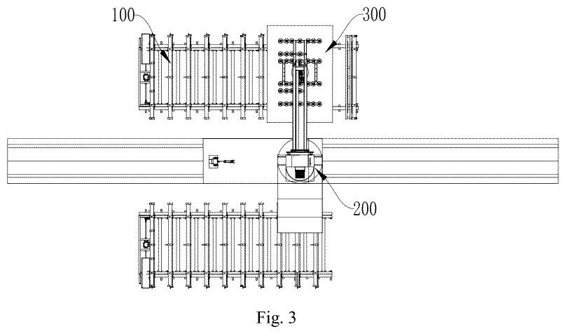

After the to-be-warehoused plate 300 is moved close to the warehousing rack, the second transfer of the to-be-warehoused plate 300 is performed, which means adjusting the to-be-warehoused plate 300 to the second posture and moving it above the warehousing rack. In this solution, the second posture refers to the horizontal setting of the to-be-warehoused plate 300, i.e., when the surface of the to-be-warehoused plate 300 is parallel to the horizontal plane, as shown in FIG. 3. This posture helps reduce the required vertical movement space during the to-be-warehoused plate 300's posture change, thus lowering the proportion of space occupied by movement in the warehouse and improving the utilization of warehouse space.

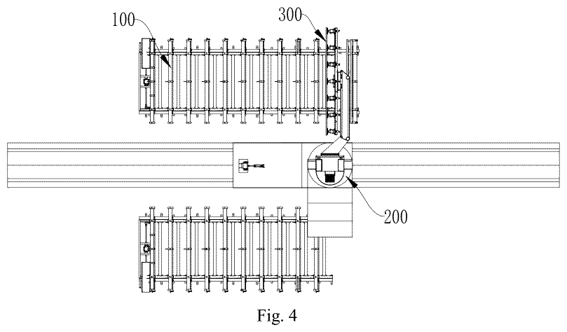

Finally, the third transfer of the to-be-warehoused plate 300 is performed, which means adjusting the to-be-warehoused plate 300 to the third posture and moving it to the storage surface of the warehousing rack. In this solution, the third posture refers to when the surface of the to-be-warehoused plate 300 is parallel to the storage surface of the vertical rack 100, as shown in FIG. 4. Using this posture to release the to-be-warehoused plate 300 during the picking process can effectively prevent damage to the to-be-warehoused plate 300 and ensure its safe storage.

It should be noted that the method for controlling plate warehousing of this solution is not only applicable to the storage of finished plates but also to the temporary storage of semi-finished plates for subsequent deep processing. Furthermore, it can be applied to the classified storage of plate leftovers to facilitate the recycling and reuse of plate remnants.

In an embodiment, when the to-be-warehoused plate is in the first posture, a width of the to-be-warehoused plate in a vertical projection direction is less than or equal to a width of the plate moving device.

When the to-be-warehoused plate 300 is in the first posture, it can be set either horizontally (i.e., the surface of the to-be-warehoused plate 300 is parallel to the horizontal plane) or vertically (i.e., the surface of the to-be-warehoused plate 300 is parallel to the vertical plane). However, to further reduce the occupied space during the first transfer of the to-be-warehoused plate 300 and to prevent the to-be-warehoused plate 300 from colliding with equipment, walls, or other structures in the storage space during movement, this solution further optimizes the first posture of the to-be-warehoused plate 300.

It should be noted that in this solution, the direction of width refers to the direction perpendicular to the movement direction of the plate moving device 200.

Further clarification: In the first posture, the to-be-warehoused plate 300 is set vertically.

In a preferred embodiment of the above-mentioned example, during the first transfer process, the to-be-warehoused plate 300 is set vertically, meaning the width of the to-be-warehoused plate 300 in the vertical projection direction is equal to the thickness of the to-be-warehoused plate 300, which is more conducive to the first transfer process.

Further clarification, when the to-be-warehoused plate 300 is in the second posture, the extension direction of the bottom edge of the to-be-warehoused plate 300 is parallel to the extension direction of the storage surface of the vertical rack 100 in the vertical projection direction.

This arrangement enables the to-be-warehoused plate 300 to be transformed into the third posture without the need to rotate the to-be-warehoused plate 300 around the axis of the vertical direction, thereby shortening the transformation path during the posture change process and improving warehousing efficiency.

It should be noted that the bottom edge of the to-be-warehoused plate 300 refers to the edge of the to-be-warehoused plate 300 that abuts against the vertical rack 100 when the to-be-warehoused plate 300 is warehoused on the storage surface of the vertical rack 100.

Further clarification: the vertical racks 100 are moved relative to the plate moving device 200, and the movement direction of the vertical rack 100 is parallel to the movement direction of the plate moving device 200.

Between step (A) and step (B), or between step (B) and step (C) or between step (C) and step (D), the method further includes step (E).
(E) A distance between the warehousing rack and a vertical rack adjacent to the storage surface of the warehousing rack is adjusted to a warehousing distance.

In a preferred embodiment of the present technical solution, the vertical rack 100 is a movable rack. When the storage rack for the to-be-warehoused plate 300 is determined, the distance between the storage rack and the adjacent vertical rack 100 in the plate placement direction (i.e., the vertical rack 100 adjacent to the storage surface of the storage rack) is increased, thereby providing sufficient space for storing the to-be-warehoused plate 300. When the storage rack is not yet determined or storage is not required, the adjacent vertical racks 100 can be brought into close contact or maintained at a narrow distance, further improving the utilization of the storage space.

It should be noted that the storage distance in this solution can be determined based on the storage information of the to-be-warehoused plate 300 or manually input via a human-machine interaction method; this is not limited herein. In addition, the movable vertical rack 100 used in this solution is a commonly used structure in the technical field of plate storage, and its specific structure is not elaborated here.

For further illustration, step (D) is specifically described as follows.

A first warehousing path is calculated based on a posture information of the to-be-warehoused plate 300 in the second posture, a posture information of the to-be-warehoused plate 300 in the third posture, the warehousing information of the to-be-warehoused plate 300, the warehousing distance and a positional information of the to-be-warehoused plate 300 in the second posture respect to the warehousing rack.

The plate moving device adjusts the to-be-warehoused plate 300 to the third posture according to the first warehousing path and to place the to-be-warehoused plate 300 onto the storage surface of the warehousing rack.

To further illustrate, step (C) is specifically as follows.

A second warehousing path is calculated based on a posture information of the to-be-warehoused plate 300 in the first posture, a posture information of the to-be-warehoused plate 300 in the second posture, the warehousing information of the to-be-warehoused plate 300, a width of the plate moving device and an allowable height above the warehousing rack.

The plate moving device adjusts the to-be-warehoused plate 300 to the second posture according to the second warehousing path and to move the to-be-warehoused plate 300 to be above the warehousing rack.

In another preferred embodiment of the present technical solution, the attitude change paths during the second and third transfer processes of the to-be-warehoused plate 300 (i.e., the corresponding second and first warehousing paths) can be calculated based on relevant parameter information, in order to shorten the transformation path during the attitude change process and improve storage efficiency, while preventing collisions of the to-be-warehoused plate 300. More preferably, both the first and second warehousing paths in this solution are arcuate paths.

It should be noted that the first and second warehousing paths in this solution can be calculated using existing algorithms, and the specific calculation process is not elaborated here.

Step (A) is specifically described as follows.

The warehousing information of the to-be-warehoused plate 300 is obtained.

The vertical rack 100 whose storage information matches the warehousing information is designated as the warehousing rack for storing the to-be-warehoused plate 300 based on the warehousing information and a storage information of the plurality of vertical racks 100.

It should be noted that the storage information corresponding to the vertical rack 100 can be randomly assigned by the system, or manually specified through human-computer interaction, which is not limited here.

The plate storage system for executing the method mentioned above includes the plurality of vertical racks 100, the plate moving device 200 and a control module. The plurality of vertical racks 100 and the plate moving device 200 are communicatively connected with the control module, the plate moving device 200 includes a mounting base 1, a column 2, a cantilever 3 and a material picking component 4, the material picking component 4 is configured to hold the to-be-warehoused plate 300.

The column 2 is provided at a top of the mounting base 1, and the column 2 is configured to rotate along an axis of the column relative to the mounting base 1.

The cantilever 3 is configured to extend horizontally from the column and is provided on a side of the column 2; and the cantilever 3 is configured to move vertically relative to the column 2 and rotate along an axis of the cantilever 3 relative to the column 2.

The material picking component 4 is provided at the cantilever 3, the material picking component 4 is configured to move horizontally relative to the cantilever 3, the material picking component 4 is configured to rotate along an axis of the material picking component 4 relative to the cantilever 3, and a rotational axis of the material picking component 4 is perpendicular to an extending direction of the cantilever 3.

In another preferred embodiment, the attitude change paths during the second and third transfer processes of the to-be-warehoused plate 300 (i.e., the corresponding first and second warehousing paths) can be calculated based on relevant parameter information, in order to shorten the transformation path during the attitude change process and improve storage efficiency, while preventing collisions of the to-be-warehoused plate 300. More preferably, both the first and second warehousing paths in this solution are arcuate paths.

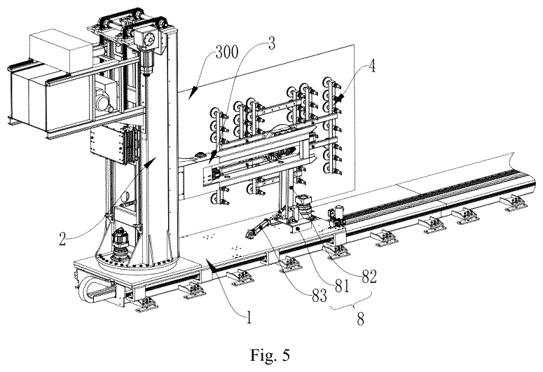

To overcome the technical drawbacks of traditional gantry-style sorting equipment, such as large floor space requirements and poor versatility and flexibility, the plate storage system applicable to this technical solution introduces the use of a plate moving device 200 to replace the traditional gantry-style sorting equipment, as shown in FIG. 5. This device includes a mounting base 1, a column 2, a cantilever 3, and a material picking component 4 for retrieving the to-be-warehoused plate 300. It should be noted that the material picking component 4 used to carry to-be-warehoused plate 300 in this solution can either pick up the to-be-warehoused plate 300 in an adsorption method or grasp the to-be-warehoused plate 300 in a clamping method, and this is not limited.

Thanks to the structural design of this solution, the material picking component 4 has relative displacement in five different directions relative to the mounting base 1, which greatly increases the degree of freedom of the material picking component 4 and better facilitates the transition of the to-be-warehoused plate 300 between different postures.

Further explanation: the plate moving device 200 also includes a support component 8, which is mounted at the top of the mounting base 1 and is used to support the material picking component 4.

In another preferred embodiment, to enhance the walking speed of the plate moving device 200 within the occupied space, this solution also specifically provides a support component 8 at the top of the mounting base 1. In addition to supporting the material picking component 4, the support component 8 can also effectively prevent the cantilever 3 from swaying during horizontal movement, thus ensuring the stable movement of the plate moving device 200.

Preferably, the support component 8 includes a fixed seat 81 and a support frame 82.

The column 2 and the fixed seat 81 are mounted at the two ends of the top of the mounting base 1, respectively; the support frame 82 includes a connecting end and a support end, with the connecting end hinged to the fixed seat 81. The support frame 82 swings about the connecting end, and the support end is used to abuts against the material picking component 4.

Specifically, the support component 8 of this solution includes a fixed seat 81 and a support frame 82, and the support frame 82 swings about the connecting end. When necessary, the support frame 82 can be made to extend vertically by swinging it, allowing the support end to contact the material picking component 4; when not necessary, the support frame 82 can be made to extend horizontally by swinging it to prevent the support frame 82 from hindering the material picking component 4 from retrieving or placing the to-be-warehoused plate 300.

In an embodiment, the support component 8 further incudes a support driver 83. The support driver 83 is mounted at the top of the mounting base 1, and an output end of the support driver 83 is connected to the support frame 82. The support driver 83 is configured to drive the support frame 82 to swing.

In an embodiment, the support frame 82 can be driven by the support driver 83 (e.g., support cylinder) to swing, so as to improve the automation level of the plate moving device 200.

The technical principles of the present disclosure have been described above in conjunction with specific embodiments. These embodiments are merely illustrative, and are not intended to limit the disclosure. It should be understood that various modifications, changes and replacements made by those skilled in the art without departing from the spirit of the disclosure shall fall within the scope of the present disclosure defined by the appended claims.

What is claimed is:

1. A method for controlling plate warehousing, the method being applied to a plate storage system, the plate storage system comprising a plurality of vertical racks and a plate moving device, the plurality of vertical racks being provided side by side at intervals along a moving direction of the plate moving device, the moving direction of the plate moving device intersecting with a plane on which a storage surface of the plurality of vertical racks is provided, and
the method comprising:
(A) obtaining a warehousing information of a to-be-warehoused plate; and determining a vertical rack among the plurality of vertical racks as a warehousing rack for storing the to-be-warehoused plate based on the warehousing information;
(B) adjusting, by the plate moving device, the to-be-warehoused plate to a first posture and moving the to-be-warehoused plate in the first posture closer to the warehousing rack;
(C) adjusting, by the plate moving device, the to-be-warehoused plate to a second posture and moving the to-be-warehoused plate above the warehousing rack; and
(D) adjusting, by the plate moving device, the to-be-warehoused plate to a third posture and placing the to-be-warehoused plate onto a storage surface of the warehousing rack;
wherein when the to-be-warehoused plate is in the first posture, a surface of the to-be-warehoused plate is parallel to the moving direction of the plate moving device;
when the to-be-warehoused plate is in the second posture, the to-be-warehoused plate is horizontally provided; and
when the to-be-warehoused plate is in the third posture, the surface of the to-be-warehoused plate is parallel to the storage surface of the warehousing rack.

2. The method of claim 1, wherein when the to-be-warehoused plate is in the first posture, a width of the to-be-warehoused plate in a vertical projection direction is less than or equal to a width of the plate moving device.

3. The method of claim 1, wherein when the to-be-warehoused plate is in the first posture, the to-be-warehoused plate is vertically provided.

4. The method of claim 1, wherein when the to-be-warehoused plate is in the second posture, an extending direction of a bottom edge of the to-be-warehoused plate is parallel to an extending direction of the storage surface of the plurality of vertical racks in a vertical projection direction.

5. The method of claim 1, wherein the plurality of vertical racks are moved relative to the plate moving device; a moving direction of the plurality of vertical racks is parallel to the moving direction of the plate moving device;
between step (A) and step (B), or between step (B) and step (C) or between step (C) and step (D), the method further comprises:
(E) adjusting a distance between the warehousing rack and a vertical rack adjacent to the storage surface of the warehousing rack to a warehousing distance.

6. The method of claim 5, wherein step (D) comprises:
calculating a first warehousing path based on a posture information of the to-be-warehoused plate in the second posture, a posture information of the to-be-warehoused plate in the third posture, the warehousing information of the to-be-warehoused plate, the warehousing distance and a positional information of the to-be-warehoused plate in the second posture respect to the warehousing rack; and
adjusting, by the plate moving device, the to-be-warehoused plate to the third posture according to the first warehousing path and to place the to-be-warehoused plate onto the storage surface of the warehousing rack.

7. The method of claim 1, wherein step (C) comprises:
calculating a second warehousing path based on a posture information of the to-be-warehoused plate in the first posture, a posture information of the to-be-warehoused plate in the second posture, the warehousing information of the to-be-warehoused plate, a width of the plate moving device and an allowable height above the warehousing rack; and
adjusting, by the plate moving device, the to-be-warehoused plate to the second posture according to the second warehousing path and to move the to-be-warehoused plate to be above the warehousing rack.

8. The method of claim 1, wherein step (A) comprises:
obtaining the warehousing information of the to-be-warehoused plate; and
designating, the vertical rack whose storage information matches the warehousing information as the warehousing rack for storing the to-be-warehoused plate, based on the warehousing information and a storage information of the plurality of vertical racks.

9. A plate storage system for executing the method of claim 1, comprising:
the plurality of vertical racks;
the plate moving device; and
a control module;
wherein the plurality of vertical racks and the plate moving device are communicatively connected with the control module;
the plate moving device comprises a mounting base, a column, a cantilever and a material picking component; the material picking component is configured to hold the to-be-warehoused plate;
the column is provided at a top of the mounting base, and the column is configured to rotate along an axis of the column relative to the mounting base;
the cantilever is configured to extend horizontally from the column and is provided on a side of the column; and the cantilever is configured to move vertically relative to the column and rotate along an axis of the cantilever relative to the column; and
the material picking component is provided at the cantilever; the material picking component is configured to move horizontally relative to the cantilever; the material picking component is configured to rotate along an axis of the material picking component relative to the cantilever, and a rotational axis of the material picking component is perpendicular to an extending direction of the cantilever.

10. The plate storage system of claim 9, further comprising:
a support component;
wherein the support component is provided at a top of the mounting base, and is configured to support the material picking component.
